(19) United States
(12) Patent Application Publication
(10) Pub. No.: US 2025/0276677 A1
(43) Pub. Date: Sep. 4, 2025

(54) METHOD FOR ASCERTAINING A POWER CYLINDER PRESSURE

(71) Applicant: Robert Bosch GmbH, Stuttgart (DE)

(72) Inventors: Christian Binder, Mainhardt (DE); Herbert Vollert, Vaihingen/Enz (DE); Manfred Gerdes, Vaihingen/Enz (DE); Oliver Fuchs, ILSFELD (DE)

(21) Appl. No.: 18/859,289

(22) PCT Filed: Jul. 31, 2024
(86) PCT No.: PCT/EP2023/071176

§ 371 Date: Oct. 23, 2024

(30) Foreign Application Priority Data
Sep. 1, 2022 (DE) 10 2022 209 076.4

(51) Int. Cl. B60T 17/22; B60T 13/14; B60T 13/74

(52) U.S. Cl. CPC B60T 17/22; B60T 13/148; B60T 13/745; B60T 2270/413; B60T 2270/88

(57) ABSTRACT

A method for ascertaining a power cylinder pressure of a power brake system. The method includes ascertaining at least one motor value of a power cylinder motor, ascertaining a potential power cylinder pressure from the motor value using a model of the correlation between the motor value and the potential power cylinder pressure, and ascertaining a power cylinder pressure using an ESP pressure sensor in the ESP brake system. The method also includes comparing the potential power cylinder pressure with the power cylinder pressure of the ESP pressure sensor taking into account a time delay between the potential power cylinder pressure and the measured power cylinder pressure of the ESP pressure sensor and correcting the correlation model in accordance with an ascertained deviation.

### FIELD

The present invention relates to a method for ascertaining a power cylinder pressure of a power brake system.

### BACKGROUND INFORMATION

The current power brake systems are characterized by the fact that they are mechanically and/or hydraulically coupled to the driver. This is achieved by using a brake pedal that is connected to an input rod. The driver braking request is detected in the full system via this input rod and a pedal feel is realized in the form of a force/travel characteristic. The pressure is then built up via a power piston that is hydraulically decoupled from the foot of the driver. To regulate this pressure build-up, the brake pressure generated via the power piston is measured via a pressure sensor. In the fallback level, the foot of the driver is then coupled to the wheel brake cylinders by means of a brake cylinder actuated by muscle power, which allows the driver to apply brake pressure using his foot. It is thus still possible to brake the vehicle in the event of a fault.

German Patent Application No. DE 10 2018 222 488 A1 describes an electrohydraulic vehicle power brake system for an autonomously driving land vehicle. Such an electrohydraulic vehicle power brake system is equipped with two redundant power brake pressure generators so that, in the event of independent driving and failure of one power brake pressure generator, the other power brake pressure generator can brake the vehicle without driver intervention.

German Patent Application No. DE 10 2019 201 536 A1 likewise describes an electrohydraulic vehicle power brake system. In this electrohydraulic vehicle power brake system, a power brake pressure generator is configured as a piston-cylinder unit which is connected to an unpressurized brake fluid reservoir by a pressure relief valve and a controllable valve. The pressure of the power brake pressure generator is measured using a pressure sensor disposed on the piston-cylinder unit. The pressure relief valve prevents pressure spikes in the vehicle brake system when the inlet valves of the hydraulic wheel brakes of the vehicle brake system are closed during a pressure build-up with the power brake pressure generator.

An object of the present invention is to provide a method for ascertaining a power cylinder pressure with which the power cylinder pressure can be ascertained more cost-efficiently. A device for carrying out such a method is to be provided as well.

The object may be achieved by a method for ascertaining a power cylinder pressure having certain features of the present invention. A device for carrying out the method of the present invention is provided, too. Advantageous example embodiments and further developments of the present invention can be found in the disclosure herein.

### SUMMARY

The present invention provides a method for ascertaining a power cylinder pressure of a power brake system. According to an example embodiment of the present invention, the method comprises the steps of ascertaining at least one motor value of a power cylinder motor, ascertaining a potential power cylinder pressure from the motor value using a model of the correlation between the motor value and the potential power cylinder pressure, and ascertaining a power cylinder pressure using an ESP pressure sensor in the ESP brake system. The method also comprises the steps of comparing the potential power cylinder pressure with the power cylinder pressure of the ESP pressure sensor taking into account a time delay between the potential power cylinder pressure and the measured power cylinder pressure of the ESP pressure sensor and correcting the correlation model in accordance with an ascertained deviation.

Power cylinder pressure is understood to be a pressure that is generated via a power cylinder to produce a braking force. In the aforementioned related art, this pressure is usually ascertained using a pressure sensor disposed directly downstream of the power cylinder. The potential power cylinder pressure is a pressure that is not measured but calculated. This potential pressure is assumed to correspond to a measured pressure. Due to uncertainties in the calculation, however, there may be a minimal difference. A motor value within the meaning of the present invention is understood to be any measured value that depends on the operating state of the motor and changes over time. The motor value is advantageously calculated using already known values, so that there is no need to use additional measurement sensors.

The correlation model is a model that can be configured as a mathematical function, for example, that can be used to ascertain a power cylinder pressure for each motor value. This correlation model includes all of the factors that affect the power cylinder pressure. Since ambient conditions such as the temperature or also the wear of the power brake system are difficult to take into account, a constant correction of the correlation model makes it possible to achieve a high degree of accuracy of the ascertained power cylinder pressure. The time delay is a time value by which the power cylinder pressure ascertained by the ESP pressure sensor is time-delayed relative to the real pressure or the potential power cylinder pressure ascertained via the correlation model.

The method of the present invention makes it possible to accurately ascertain the power cylinder pressure without using a pressure sensor. The costs for a pressure sensor can thus be saved, so that the power cylinder pressure can be ascertained in a cost-efficient manner.

In a preferred embodiment of the present invention, the propagation time of the measured power cylinder pressure of the ESP pressure sensor is measured and the time delay between the potential power cylinder pressure and the measured power cylinder pressure of the ESP pressure sensor is adjusted based on the propagation time. The time delay can be determined by ascertaining the propagation time, so that the pressure difference and with it the correlation model can be calculated more accurately. The potential power cylinder pressure can thus be determined more accurately, which improves the regulation of the power cylinder. The propagation time is advantageously measured regularly in order to achieve a consistently high degree of accuracy.

In another preferred embodiment of the present invention, the propagation time of test signals is ascertained to measure the time delay. Such a test signal can include a time of transmission. The propagation time can easily be ascertained by comparing the time of reception with the time of transmission. The propagation time can thus easily be measured independently of a braking maneuver, which increases the accuracy of the ascertained potential power cylinder pressure.

Preferably, the torque is used as the motor value to ascertain the potential power cylinder pressure. The torque can be measured. This value can also be calculated in the control unit. It is thus easily possible to determine the torque.

In an advantageous further development of the present invention, the motor current as the motor value is used to ascertain the potential power cylinder pressure. Since the motor current is known due to the regulation via the control unit, this value does not have to be ascertained. This makes it easy to determine a motor value.

The object of the present invention may be further achieved by a device for carrying out the method. The device comprises a power cylinder, via which a power cylinder pressure can be generated with a power cylinder motor, an ESP pressure sensor, via which a time-delayed pressure of the power cylinder pressure can be measured, and a control unit, in which a potential power cylinder pressure can be ascertained using a model of the correlation between a motor value and the potential power cylinder pressure. Ascertaining the power cylinder pressure in this way makes it possible to provide a power cylinder pressure measurement without a pressure sensor. The advantages mentioned with respect to the method are similarly achieved with such a device.

Embodiment examples of the present invention are shown in the figures and explained in more detail in the following description.

### BRIEF DESCRIPTION OF THE DRAWINGS

FIG. 1 shows an embodiment example of a power brake system, in which the power cylinder pressure is to be ascertained according to the method according to the present invention.

FIG. 2 shows an embodiment example of a method for ascertaining a power cylinder pressure of a power brake system, according to the present invention.

FIG. 3 shows embodiment example of a method for determining the time delay, according to the present invention.

### DETAILED DESCRIPTION OF EXAMPLE EMBODIMENTS

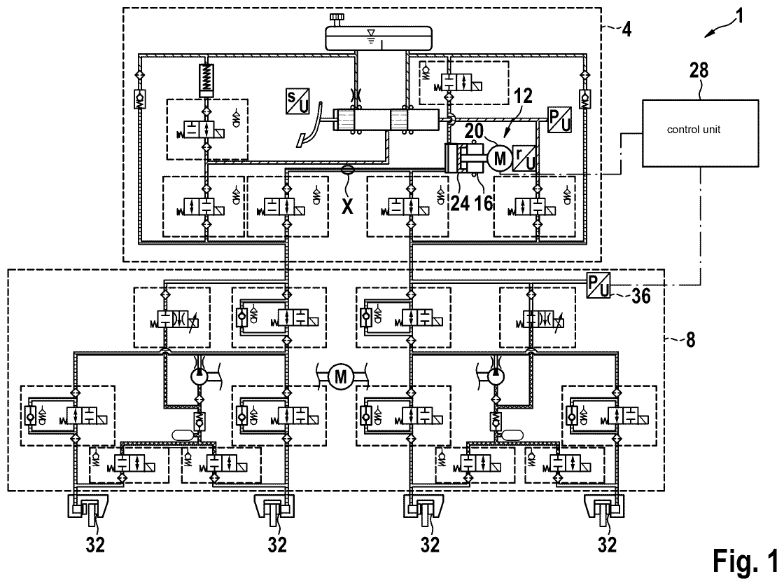

FIG. 1 shows an embodiment example of a power brake system 1, in which the power cylinder pressure is to be ascertained according to the method according to the present invention. The power brake system 1 comprises two units 4, 8. A first unit 4 shows a substantially conventional power system. A detailed description is therefore omitted and only components relevant to the present invention will be discussed. The first unit 4 comprises a power brake pressure generator 12 with a power cylinder 16, via which the power cylinder pressure can be generated with a power cylinder motor 20 by moving a power piston 24. The power cylinder motor 20 is connected to a control unit 28 via which this motor 20 is controlled. The power cylinder pressure is applied at a point X. In the related art, a power cylinder pressure sensor is typically disposed at this point X to ascertain the power cylinder pressure. In the power brake system 1, however, the power cylinder pressure is ascertained without using a power cylinder pressure sensor.

The second unit 8 in the present embodiment example is an ESP brake system, via which a brake pressure can be applied to the wheel brakes 32. An ESP pressure sensor 36, which is also connected to the control unit 28 to transmit the pressure to said control unit, is provided to measure the brake pressure in the ESP brake system 8. The rest of the ESP brake system 8 is configured in a conventional manner; a detailed description is therefore omitted.

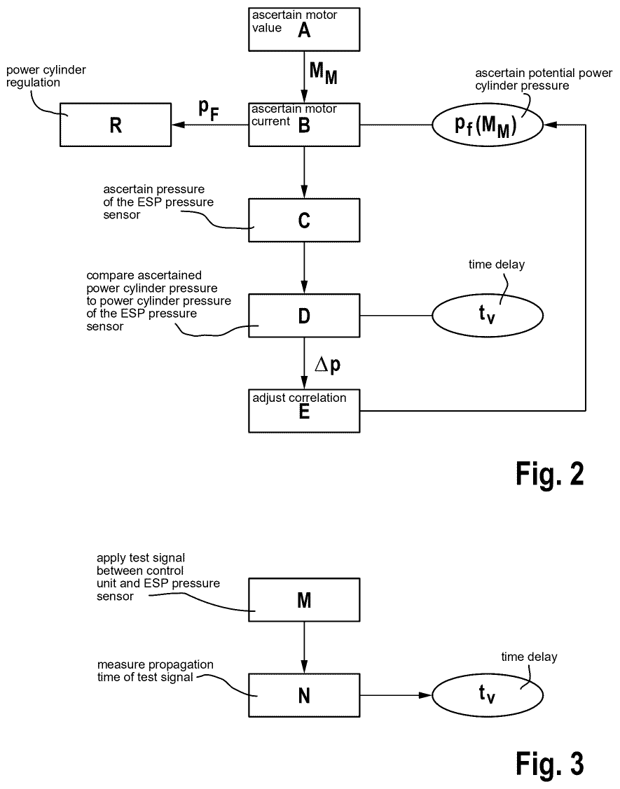

FIG. 2 shows an embodiment example of a method for ascertaining a power cylinder pressure of the power brake system 1 described in FIG. 1. In a first step A, a motor value of the power cylinder motor 20 is ascertained. In this embodiment example, the torque M_{M} is ascertained. Since this value is ascertained by default, no additional sensors are needed for this purpose. Alternatively, it is also possible to ascertain the motor current of the power cylinder motor 20. In a second step B, the potential power cylinder pressure p_{F} is ascertained on the basis of the torque M_{M}. A correlation p_{F} (M_{M}) between the potential power cylinder pressure pF and the torque M_{M} is used for this purpose. The correlation p_{F} (M_{M}) can include values such as the gear characteristics of the power cylinder motor 20, the elasticity of the brake system and a piston surface area.

The thus ascertained potential power cylinder pressure p_{F} is used for the power cylinder regulation R, so there is therefore no need for a separate pressure sensor. In a third step C, the pressure of the ESP pressure sensor 36 is ascertained. This is transmitted to the control unit 28. In a fourth step D, the ascertained power cylinder pressure p_{F} is compared in the control unit 28 to a power cylinder pressure p_{ESP} of the ESP pressure sensor 36. Due to the delayed transmission of the power cylinder pressure p_{ESP} of the ESP sensor 36 to the control unit 28 and the signal processing, the power cylinder pressure p_{ESP} of the ESP sensor 36 has a time delay t_{V} relative to the ascertained potential power cylinder pressure p_{F}. This time delay t_{V} is taken into account for the power cylinder pressure p_{ESP} when comparing the two values.

If a deviation Δp between the two values is detected in the comparison, the correlation p_{F} (M_{M}) is adjusted in accordance with the deviation Δp and saved again for the calculation of the potential power cylinder pressure p_{F} in a fifth step E. This makes it possible to increase the accuracy of the ascertained potential power cylinder pressure p_{F}.

FIG. 3 shows an embodiment example of a method for determining the time delay t_{V}. In a first determination step M, a test signal is applied between the control unit and the ESP pressure sensor. In a second determination step N, the propagation time of the test signal is measured. The propagation time is used to calculate the time delay t_{V}. This value can then be updated in the method according to FIG. 2. The corrected value of the time delay t_{V} increases the accuracy when comparing the two values, which makes it possible to ascertain a more accurate correlation p_{F} (M_{M}).

1-6. (canceled)

7. A method for ascertaining a power cylinder pressure of a power brake system, comprising the following steps:
ascertaining at least one motor value of a power cylinder motor;
ascertaining a potential power cylinder pressure from the motor value using a correlation model of a correlation between the motor value and the potential power cylinder pressure;
ascertaining a power cylinder pressure using an ESP pressure sensor in an ESP brake system;
comparing the potential power cylinder pressure with the power cylinder pressure of the ESP pressure sensor taking into account a time delay between the potential power cylinder pressure and the measured power cylinder pressure of the ESP pressure sensor; and
correcting, based on the comparing, the correlation model in accordance with an ascertained deviation.

8. The method according to claim 7, wherein a propagation time of the measured power cylinder pressure of the ESP pressure sensor is measured and the time delay between the potential power cylinder pressure and the potential power cylinder pressure of the ESP pressure sensor is adjusted based on the propagation time.

9. The method according to claim 8, wherein the propagation time of test signals is ascertained to measure the time delay.

10. The method according to claim 7, wherein a torque is used as the motor value to ascertain the potential power cylinder pressure.

11. The method according to claim 7, wherein a motor current is used as the motor value to ascertain the potential power cylinder pressure.

12. A device, comprising:
a power cylinder, via which a power cylinder pressure can be generated with a power cylinder motor;
an ESP pressure sensor, via which a time-delayed pressure of the power cylinder pressure can be measured; and
a control unit, in which a potential power cylinder pressure can be ascertained using a correlation model of a correlation between a motor value and the potential power cylinder pressure;
wherein the device is configured to:
ascertain the motor value,
ascertain the potential power cylinder pressure from the motor value using the correlation model,
ascertain the power cylinder pressure using the ESP pressure sensor,
compare the potential power cylinder pressure with the power cylinder pressure of the ESP pressure sensor taking into account a time delay between the potential power cylinder pressure and the measured power cylinder pressure of the ESP pressure sensor, and
correct, based on the comparing, the correlation model in accordance with an ascertained deviation.
